(19) United States
(12) Patent Application Publication
(10) Pub. No.: US 2017/0266895 A1
(43) Pub. Date: Sep. 21, 2017

(54) MOLDING TOOL ASSEMBLY

(71) Applicant: Carbon Rotec GmbH & Co. KG, Lemwerder (DE)

(72) Inventors: Hanno Kehlenbeck, Bremen (DE); Matthias Friedrichs, Bremen (DE)

(73) Assignee: Carbon Rotec GmbH & Co. KG, Lemwerder (DE)

(21) Appl. No.: 15/460,289

(22) Filed: Mar. 16, 2017

(30) Foreign Application Priority Data
Mar. 21, 2016 (DE) 102016003326.6

(51) Int. Cl. B29C 70/54

(52) U.S. Cl. CPC B29C 70/541; B29L 2031/085

(57) ABSTRACT

A molding tool assembly, in particular for producing rotor blades of wind power plants, having a first mold shell (20) and a second mold shell (22) each for receiving one workpiece part, wherein the two mold shells in a proximal position face one another but do not bear on one another, having securing means for holding a workpiece part in at least one of the mold shells and having centering means for mutually centering the two mold shells in the proximal position or during convergence of the mold shells. The centering means and the securing means are mechanically intercoupled.

### STATEMENT OF RELATED APPLICATIONS

This patent application claims the benefit of and priority on German Patent Application No. 10 2016 003 326.6 having a filing date of 21 Mar. 2016.

### BACKGROUND OF THE INVENTION

Technical Field

The invention relates to a molding tool assembly, in particular for producing rotor blades for wind power plants, having a first mold shell and a second mold shell each for receiving one workpiece part, wherein the two mold shells in a proximal position face one another but do not bear on one another, having securing means for holding a workpiece part in at least one of the mold shells and having centering means for mutually centering the two mold shells in the proximal position or during convergence of the mold shells. The invention moreover relates to a method for producing a workpiece from two half-shell type workpiece parts, in particular for producing a rotor wing for wind power plants.

Prior Art

In the production of rotor blades for wind power plants, initially two half shells from a composite material are typically prefabricated in the respective mold shells that are provided therefor and are open towards the top. The mold shells having the half shells lying therein are subsequently positioned on top of one another in such a manner that a closed rotor-blade profile is created.

One of the mold shells is preferably disposed so as to be stationary, while the other mold shell is rotatable about 180° and in an overhead position is depositable on the aforementioned mold shell. To this end, the two mold shells can be interconnected by way of an articulation, the articulation line (pivot axis) of the latter running in the longitudinal direction of the mold shells.

Unintentional releasing of the half shells from the mold shells is to be avoided by way of the molding tool assembly according to the invention, in particular in an overhead position of one of the mold shells. Preferably, the two mold shells are to be precisely positionable in relation to one another and interconnectable so as to resist a tensile force. The half shells hereunder are referred to as workpiece parts.

The operation of the molding tool assembly in particular is to be possible in a simpler and safer manner.

### BRIEF SUMMARY OF THE INVENTION

In order for the object to be achieved, the molding tool assembly according to the invention is a molding tool assembly, in particular for producing rotor blades for wind power plants, having a first mold shell and a second mold shell each for receiving one workpiece part, wherein the two mold shells in a proximal position face one another but do not bear on one another, having securing means for holding a workpiece part in at least one of the mold shells and having centering means for mutually centering the two mold shells in the proximal position or during convergence of the mold shells, characterized in that the securing means and the centering means are mechanically intercoupled. The securing means hold the workpiece part in particular in the proximal position of the mold shells and/or during rotation. Said securing means are preferably mechanical securing means which are disposed on the periphery of the mold shell and impinge on a periphery of the workpiece part such that the workpiece cannot fall out of the respective mold shell. Due to the large extent of the mold shells for the production of rotor blades, many securing means can be disposed at defined mutual spacings along the mold shell periphery. Moreover, centering means are provided for mutually centering the two mold shells in the proximal position or during convergence of the mold shells. The centering means are preferably assigned to the securing means in spatial terms and/or provided in the same number. At the same time, the securing means and the centering means are mechanically intercoupled. This enables a simpler and safer operation of the assembly.

According to a further concept of the invention, the centering means and the securing means are intercoupled by common drive means. For example, the securing means and the centering means are embodied such that the former are to be rotated and moved in a linear manner. One common drive means performs the rotation and one further common drive means performs the linear movement. The drive means can also be combined so as to form a single drive installation.

According to a further concept of the invention, the centering means each include a centering head and a centering receptacle, wherein the centering head is assigned to the one mold shell and the centering receptacle is assigned to the other mold shell, and wherein the centering head and the centering receptacle are preferably configured so as to be conical and mutually matching. The centering head and the centering receptacle in terms of their shape are configured such that they can be converged and thereby mutually engage, even when they are not precisely aligned with one another. It is the conical configuration that specifically causes this type of self-centering. The centering head is preferably moved in the direction towards the centering receptacle, hereby moving into the centering receptacle, or vice versa. The conical shape herein can be restricted to a direction that is transverse to the direction of movement, such as in the case of a wedge.

According to a further concept of the invention, the centering means and the securing means are mechanically intercoupled in such a manner that in the case of a movement of the centering head or of the centering receptacle in the direction towards the respective other mold shell, the securing means or part of the latter is simultaneously moved in the direction towards the other mold shell. A common drive can be used by virtue of the coupling between the centering means and the securing means (or part of the latter).

According to a further concept of the invention, a molding tool assembly is a molding tool assembly, in particular for producing rotor blades for wind power plants, having a first mold shell and a second mold shell each for receiving one workpiece part, wherein the two mold shells in a proximal position face one another but do not bear on one another, and having securing means for holding a workpiece part in at least one of the mold shells, characterized by locking means for a tensile-force-absorbing connection between the two mold shells. In particular, locking means for a tensile-force-absorbing connection between the two mold shells are provided. The locking means preferably act in a form-fitting manner and allow forces for moving the two mold shells in relation to one another to be applied.

According to a further concept of the invention, the securing means and the locking means are intercoupled by common drive means. For example, the securing means and the locking means are embodied such that the former are to be rotated and moved in a linear manner. One common drive means performs the rotation and one further common drive means performs the linear movement. The drive means can also be combined to form a single drive installation.

According to a further concept of the invention, the locking means in each case include a locking head and a locking receptacle, wherein the locking head is assigned to the one mold shell and the locking receptacle is assigned to the other mold shell, and wherein the locking head is connectable to the locking receptacle preferably by plug-fitting and rotating. In particular, the locking head and the locking receptacle have a protrusion and a groove, as in the case of a bayonet fitting.

According to a further concept of the invention, the securing means and the locking means are mechanically intercoupled in such a manner that in the case of a movement of the locking head or of the locking receptacle the securing means is simultaneously moved. By virtue of the mechanical coupling, a common drive suffices for the securing means and the locking means.

According to a further concept of the invention, the locking head is rotatable from an ingress position to a locking position, in particular from an initial position to the ingress position. The rotational capability preferably extends across approximately 270°.

According to a further concept of the invention, the locking head is moved in a range between the initial position and the ingress position when a holding arm of the securing means is moved from a securing position to a free position. The respective workpiece part is secured or held, respectively in the mold shell when the holding arm is located in the securing position. The workpiece part in the mold shell is not secured in the free position of the holding arm. In the ingress position, the locking head is movable into the locking receptacle. In a locking position, there is a tensile-force-absorbing connection between the locking head and the locking receptacle.

According to a further concept of the invention, the locking means is assigned a linear unit by way of which in particular a locking head is movable substantially in the direction that is perpendicular to an opening plane of the assigned mold shell. The linear unit in a simple manner enables a targeted direction of movement of the locking head.

According to a further concept of the invention, the mold shells by means of the linear unit are movable from the proximal position in the direction towards a contacting position in which the mold shells and/or workpiece parts that are lying in the mold shells are in mutual contact. The workpiece parts in the contacting position are interconnectable, in particular by adhesive bonding.

According to a further concept of the invention, the locking means is assigned a rotary unit by way of which a locking head is rotatable relative to a locking receptacle. Rotation is preferably performed about an axis that is parallel to the movement of a linear unit that is likewise provided. In particular, the rotation axis lies in the alignment of movement of the linear unit. The rotary unit and the linear unit can be parts of a displacement unit. Also, the rotary unit and the linear unit, independently of one another, can be provided with dedicated drives, or be mechanically intercoupled.

According to a further concept of the invention, a holding arm of the securing means is simultaneously pivotable by way of the rotary unit. In this embodiment, the rotary unit is the common drive for the locking head and the holding arm.

According to a further concept of the invention, the locking head is simultaneously a centering head, while the locking receptacle is simultaneously a centering receptacle. The combination of the two functions in each case in one component reduces the overall complexity of the assembly.

According to a further concept of the invention, a holding arm of the securing means is pivotable about a pivot axis and foldable about a folding axis that is perpendicular thereto. On account thereof, the holding arm can be moved such that an obstruction of other parts is avoided.

According to a further concept of the invention, the securing means, the centering means, and/or the locking means are part of a displacement unit, wherein a plurality of displacement units are provided at defined spacings along at least one of the two mold shells, specifically along the longitudinal sides thereof. The displacement units are preferably disposed on both sides of the mold shell, approximately every two meters. Accordingly, the respective other mold shell has means corresponding thereto every two meters.

According to a further concept of the invention, a molding tool assembly is a molding tool assembly, in particular for producing rotor blades for wind power plants, having a first mold shell and a second mold shell each for receiving one workpiece part, wherein the two mold shells in a proximal position face one another but do not bear on one another, and wherein centering means are provided for mutually centering the two mold shells in the proximal position, characterized in that the centering means are assigned locking means in such a manner that, by way of the centering means and the locking means, a connection is establishable between the two mold shells, wherein the connection also absorbs tensile forces. A first mold shell and a second mold shell each for receiving one workpiece part are provided in particular, wherein the two mold shells in a proximal position face one another but do not bear on one another, and wherein centering means are provided for mutually centering the two mold shells in the proximal position, in particular in conjunction with further features as stated above. Herein, the centering means are assigned locking means in such a manner that, by way of the centering means and the locking means, a connection is establishable between the two mold shells, wherein the connection also absorbs tensile forces. The connection is in particular form-fitting. The connection preferably also absorbs compressive forces.

According to a further concept of the invention, the centering means act in a centering manner at least in one direction, in particular transversely to a longitudinal direction of the mold shells. The longitudinal direction of the mold shells herein corresponds to the longitudinal direction of the finished rotor blades. The centering means advantageously act in a centering manner in all directions that are parallel to an opening plane of the mold shell.

According to a further concept of the invention, the centering means are adjustable in a manner parallel to an opening plane of the mold shell, in particular transversely to a longitudinal direction of the mold shell. In order for centering to be finely tuned, the centering head and/or the receptacle can be adjusted by way of suitable adjustment members, for example.

According to a further concept of the invention, the locking means, for moving the two mold shells from the proximal position to an even more proximal position and vice versa, are connected to a drive unit. In this case, the drive unit is preferably a linear unit and part of a displacement unit to which locking means are assigned.

The method according to the invention is a method for producing a workpiece from two half-shell type workpiece parts, in particular for producing a rotor wing for wind power plants, using a molding tool assembly according to the invention. Said method relates to the production of a workpiece from two half-shell type workpiece parts, in particular of a rotor wing for wind power plants, using the molding tool assembly according to the invention. Preferably, a first workpiece part that is lying in an mold shell that is open towards the top is connected to a second workpiece part that is lying in a second mold shell that is open towards the top, and to this end the first mold shell is rotated about 180° and moved towards the second mold shell. The first workpiece part on the peripheries is initially secured by securing means in the first mold shell. The first mold shell is then rotated about 180° and moved to a proximal position above the second mold shell. The first mold shell herein can be permanently or merely temporarily held in an articulation system. Thereafter, the securing means, and preferably also the articulation system, are released. The two mold shells are subsequently interconnected by way of a plurality of tensile-force-absorbing connections. The first mold shell is finally lowered further until the workpiece parts are in contact. To this end, the first mold shell is actively pulled against the second mold shell in particular. After the two workpiece parts have been connected, the first mold shell is actively released, in particularly lifted, from the second mold shell. The workpiece is thereby released from the first mold shell.

### BRIEF DESCRIPTION OF THE DRAWINGS

Further features of the invention can be derived from the remaining part of the description and from the claims. Advantageous exemplary embodiments of the invention will be explained in more detail hereunder by means of drawings. In the drawings:

FIG. 1 shows a cross section of part of a movable mold shell having a displacement unit, a rotary unit, a holding arm, and a locking head, in an initial position;

FIG. 2 shows part of a stationary mold shell;

FIG. 3 shows the mobile mold shell according to FIG. 1, having an inwardly pivoted holding arm above a mold shell periphery;

FIG. 4 shows the mobile mold shell according to FIG. 3 having a holding arm that bears on the mold shell periphery (pinch edge);

FIG. 5 shows parts of the two mold shells, specifically the mobile mold shell that has been pivoted about 180° above the stationary mold shell, wherein the two mold shells in a proximal position still have a mutual spacing, and the holding arm bears on the mold shell periphery of the mobile mold shell;

FIG. 6 shows the two mold shells according to FIG. 5, but having a holding arm that is slightly lifted from the mold shell periphery;

FIG. 7 shows the two mold shells according to FIG. 6, but having a holding arm that is pivoted away from the mold shell periphery and folded onto a displacement unit;

FIG. 8 shows the mold shells according to FIG. 7, but having a locking head that is retracted into a locking receptacle;

FIG. 9 shows the two mold shells according to FIG. 8, but having a locking head that is rotated in the locking receptacle, in order for a form-fitting connection (for locking) to be established;

FIG. 10 shows the mold shells according to FIG. 9, but having a lowered mobile mold shell, such that the latter bears on the stationary mold shell;

FIG. 11 shows the mold shell according to FIG. 10, but having diverged mold shells, the locking still being maintained;

FIG. 12 shows the two mold shells according to FIG. 11, but having a rotated and thus unlocked locking head;

FIG. 13 shows the mold shells according to FIG. 12, but having a locking head that has been deployed out of the locking receptacle;

FIG. 14 shows the mold shells according to FIG. 13, but having a locking head that has been rotated back, in a manner analogous to FIG. 11;

FIG. 15 shows the mobile mold shell in manner analogous to FIG. 1, but having a fixed projecting holding arm;

FIG. 16 shows part of the stationary mold shell in a manner analogous to FIG. 2, having a larger embodiment of the locking receptacle;

FIG. 17 shows parts of the two mold shells according to FIGS. 15 and 16, in a manner analogous to the illustration in FIG. 9, specifically having a locking head that is locked in the locking receptacle;

FIG. 18 shows the mold shells as in FIG. 17, in a position that is analogous to that of FIG. 14;

FIG. 19a shows a particular embodiment of a locking head, having a locking receptacle in a proximal position;

FIG. 19b is analogous to FIG. 19a, but showing a retracted position; and

FIG. 19c is analogous to FIG. 19a, but showing a locking position.

### DETAILED DESCRIPTION OF PREFERRED EMBODIMENTS

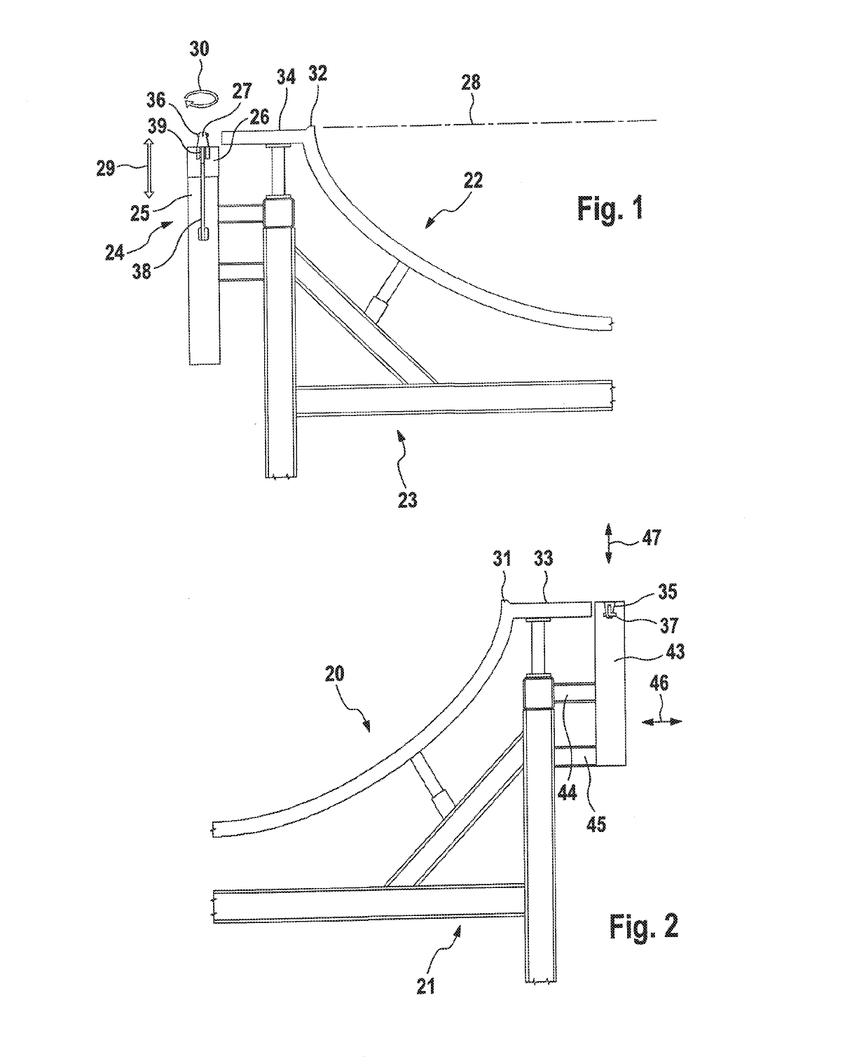

A molding tool assembly has a stationary mold shell 20 on a frame 21, see FIG. 2, the latter showing only the right half of the mold shell 20 and the frame 21. Matching thereto, a further mold shell 22 is provided on a movable frame 23, see FIG. 1. Means for moving the frame 23 with the mold shell 22 are known in principle. For example, the movable frame 23 can be connected to the stationary frame 21 by way of an articulation (not shown). Accordingly, an articulation axis in this instance extends in the longitudinal direction of the mold shell, in this case so as to be perpendicular to the image plane. The molding tool assembly is provided for the production of rotor blades.

A displacement unit 24 for a locking means is assigned to the mold shell 22 and provided on the frame 23. The displacement unit 24 here has a linear unit 25 and a rotary unit 26. By means of the linear unit 25 a locking head 27 of the locking means is movable in the direction that is perpendicular to an opening plane 28 of the mold shell 22, see double arrow 29. The rotary unit 26 enables rotation of the locking head 27 about an axis that is perpendicular to the opening plane 28, see rotation arrow 30.

Fibrous material (not shown) is laid up in the two mold shells 20, 22 and is soaked with artificial resin. The fibrous mats herein by way of pinch edges 31, 32 reach up to the mold peripheries 33, 34. After the casting resin has cured, the mold shell 22 with the frame 23 is pivoted about 180° and deposited on the stationary mold shell 20 such that half shells that have been created in the mold shells 20, 22 are interconnectable as workpiece parts.

A locking receptacle 35 on the frame 21 of the stationary mold shell 20 is also a component part of the locking means mentioned. The locking head 27 and the locking receptacle 35 are configured in a mutually corresponding manner. The locking head 27 is conical or cone-shaped, respectively, having cams 36 that project transversely from the tip thereof. The locking receptacle 35 has a conical or cone-shaped depression, respectively, having L-shaped grooves 37 for receiving the cams 36.

By way of the cone-shaped/conical design, the locking head 27 and the locking receptacle 35 not only form the locking means but also simultaneously a centering means, or the centering head and the centering receptacle, respectively. The locking head 27 can enter the locking receptacle 35 with a relatively high degree of play. On account thereof, tolerances that are parallel to the opening plane 28 can be equalized.

The displacement unit 24 is moreover assigned a securing means which here has a holding arm 38 which is pivotably held on an articulation 39 on the locking head 27 or on the rotary unit 26, respectively. FIG. 1 shows a parking position of the holding arm 38 that is perpendicular to the opening plane 28, or bears on the linear unit 25, respectively.

The mold shell 22 having the movable frame 23 on the longitudinal sides of the former (not shown) is assigned a plurality of displacement units 24 having the features described, there being one displacement unit every 2 meters, for example. In a manner corresponding thereto, the stationary mold shell 20 having the frame 21 on the two longitudinal sides of the former has a corresponding number of locking receptacles 35.

The linear unit 25 and the rotary unit 26 can be pneumatically, hydraulically, electrically, or electromagnetically driven. The action of the rotary unit 26 can also be performed in a positively guided manner, so as to depend on a movement of the linear unit 25. The rotary unit 26 preferably has a rotating range of 270 degrees and supports both the holding arm 38 as well as the locking head 27. Proceeding from the parking position of the rotary unit 26 at 0 degrees as shown in FIG. 1, three ranges of 90 degrees each result:

Range 0 to 90 degrees, having a locking function (to be explained further below) and having an inwardly folded holding arm 38;

Range 90 to 180 degrees: outward folding of the holding arm;

Range 180 to 270 degrees: inward pivoting of the holding arm to a securing position (also referred to as the operating position).

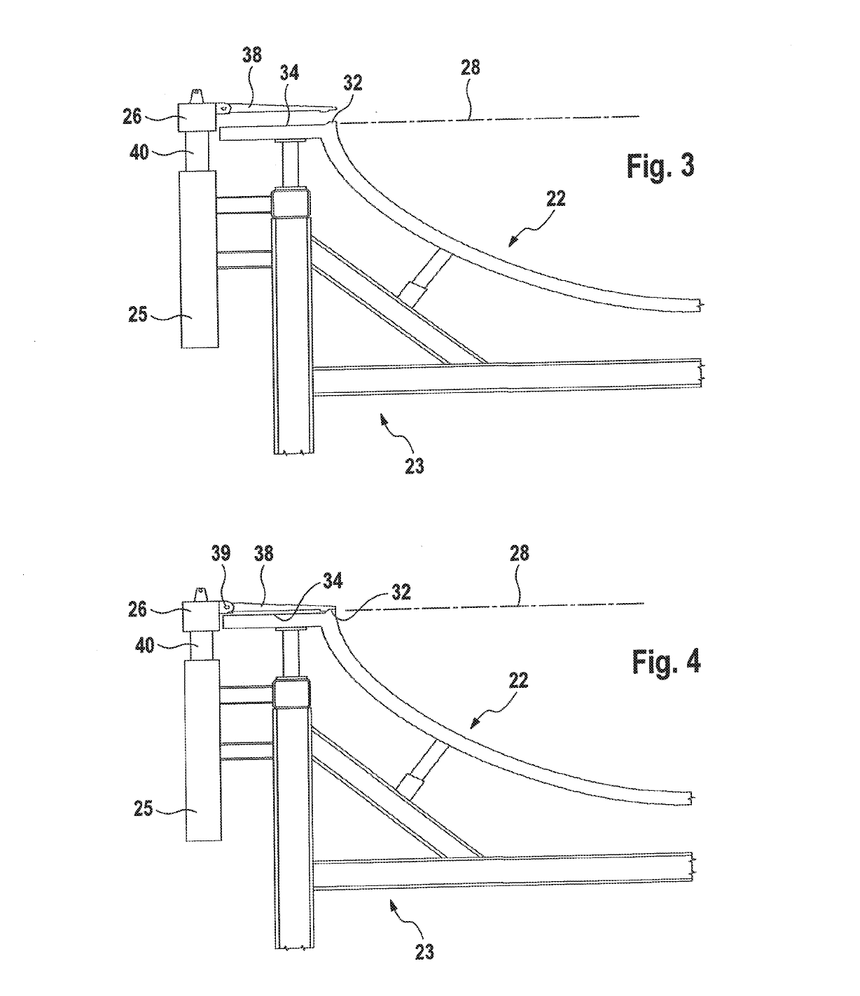

The function of the displacement unit 24 and the sequence in the production of a rotor wing for a wind power plant will be explained hereunder by means of FIGS. 3 to 14. It is assumed herein that one cured half shell for the production of the rotor wing is located in each of the two mold shells 20, 22. Both mold shells 20, 22 are disposed having an opening that faces the top, in a manner corresponding to FIGS. 1 and 2. Projecting peripheries of the half shells (not shown) bear at least in part on the pinch edges 31, 32 or on the mold peripheries 33, 34. Lifting the mold shell 22 with the frame 23, rotating the former about 180 degrees, and depositing on the stationary mold shell 20 with the frame 21 are required actions that are known per se.

Proceeding from the position of the rotary unit 26 and of the holding arm 38 in FIG. 1, and in order to achieve the position according to FIG. 3, the linear unit 25 is initially activated such that the rotary unit 26 on a piston rod 40 is upwardly deployed to an external position that corresponds to the illustration in FIG. 3. However, the holding arm 38 still remains in the position according to FIG. 1. The rotary unit 26 with the holding arm 38 is subsequently rotated outwardly about 90 degrees, that is to say to the left in FIG. 1. The rotary unit 26 and the holding arm 38 are thereafter rotated about a further 90 degrees. The holding arm 38 herein is folded out to a horizontal position (not shown), and then extends into the image plane. Thereafter, the holding arm 38 is rotated about a further 90 degrees to the position according to FIG. 3.

Lifting of the holding arm 38 from the vertical position according to FIG. 1 to the horizontal position according to FIG. 3 can be performed by a drive (not shown) or manually. Positive guiding, so as to depend on the movement of the rotary unit 26 or of the linear unit 25, is also possible.

The holding arm 38 in FIG. 3 is at a minor spacing above the pinch edge 32 having the mold periphery 34. As can be seen from FIG. 4, in the next step the holding arm 38 by way of the rotary unit 26 is lowered slightly to a central position, and then bears as tightly as possible on the pinch edge 32 or on the mold periphery 34, respectively. On account thereof, the projecting periphery (not shown) of the cured half shell is jammed between the pinch edge 32 and the holding arm 38. The holding arm 38 in this manner has the function of a shell-securing clamp.

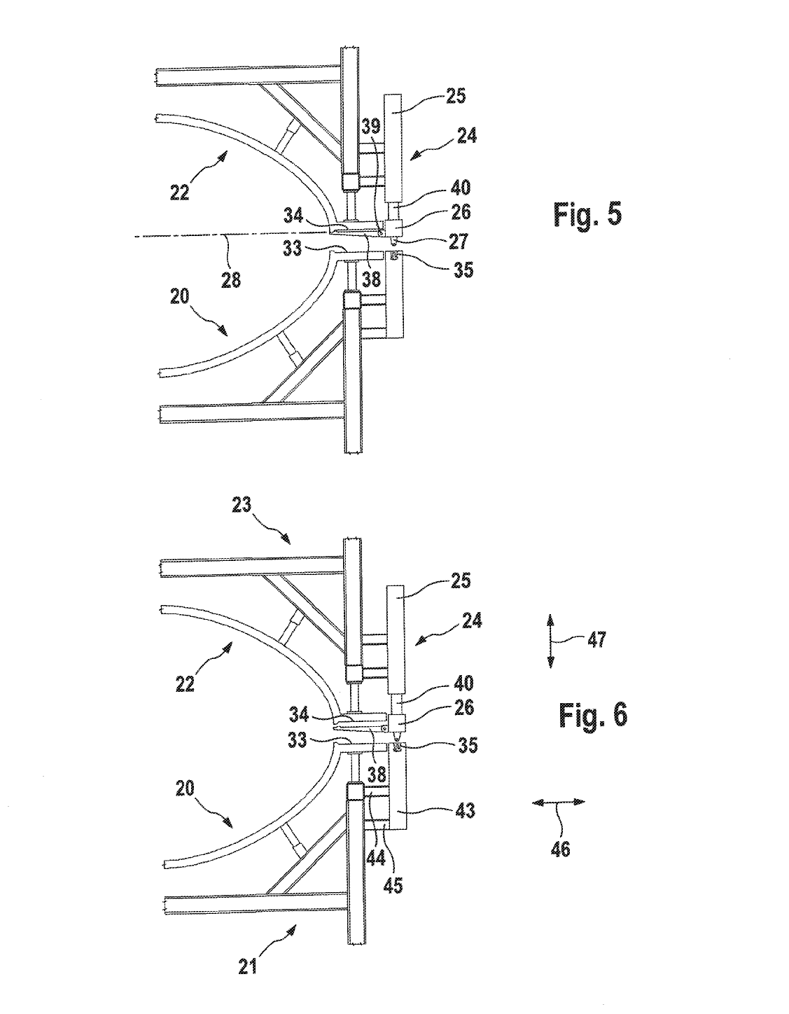

The mold shell 22 with the frame 23 is subsequently lifted, pivoted about 180 degrees preferably by an articulation system (not shown), and held in a proximal position above the stationary mold shell 20, see FIG. 5. An obvious spacing between the mold peripheries 33, 34 can still be seen while the holding arm 38 carries out the holding function thereof and bears as tightly as possible on the mold periphery 34. The locking head 27 is located above the locking receptacle 35, being spaced apart therefrom.

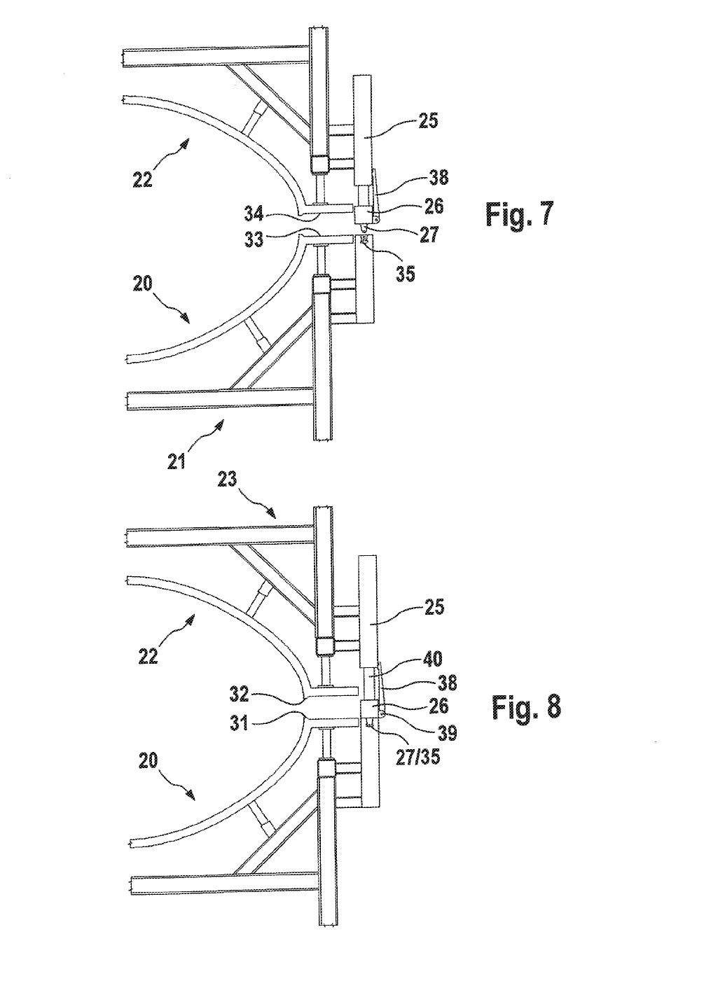

In the next step, the rotary unit 26 by way of the piston rod 40 of the linear unit 25 is again moved to the external position according to FIG. 3, that is to say in the downward direction in FIG. 6. On account thereof, the holding arm 38 is released from the mold periphery 34. The rotary unit 26 subsequently pivots the holding arm 38 about 180 degrees. The holding arm 38 remains folded out in a horizontal manner during the first 90 degrees. Thereafter, the holding arm 38 pivots to the vertical position according to FIG. 7 and hereby can come to bear on the linear unit 25.

In the next step, the locking head 27 is deployed further by the linear unit 25, that is to say in FIG. 8 is lowered downwards into the locking receptacle 35. The two mold shells 20, 22 continue to be mutually spaced apart in the same manner as in FIGS. 5 to 7. The mold shells 20, 22 herein in the proximal position are held so as to be spaced apart by the articulation system (not shown).

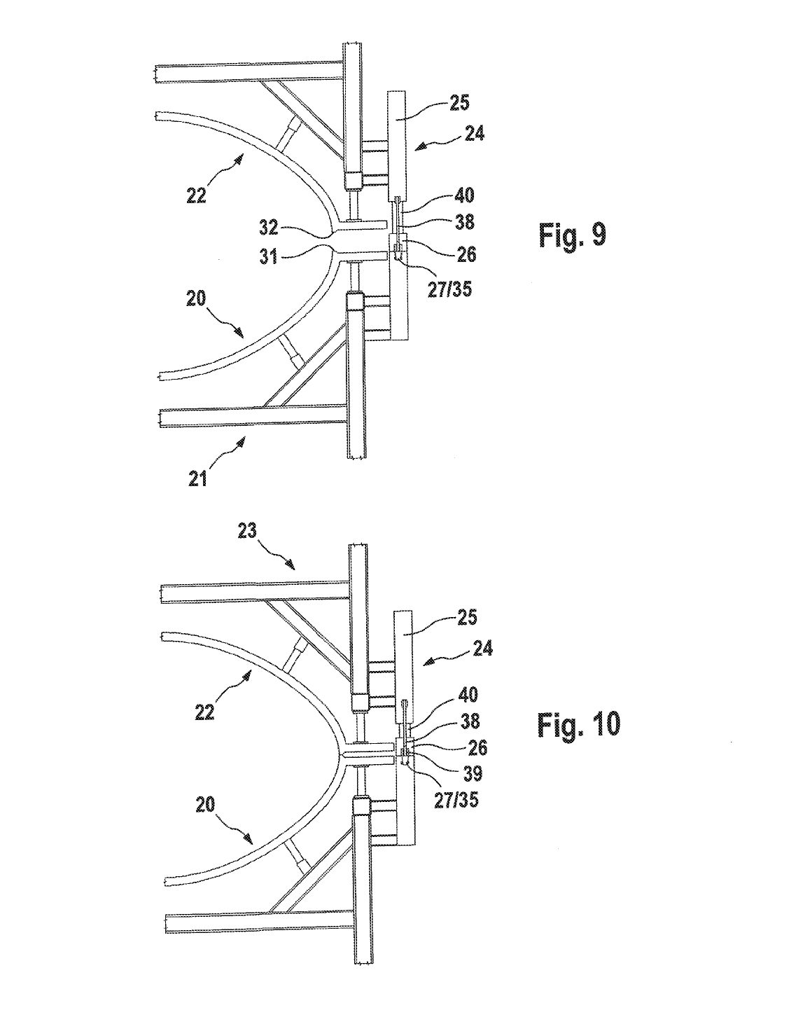

Subsequently, or in a later step, the locking head 27 is rotated by the rotary unit 26 about 90 degrees to the position according to FIG. 9. The locking head 27 is then locked in the locking receptacle 35 and by simple traction can no longer exit from the locking receptacle 35. A form-fitting connection by way of which tensile forces and compressive forces can be transmitted is established between the two frames 21, 23. The articulation system (not shown) which still interconnects the frames 21, 23 can be released such that the frames 21, 23 are still connected to the corresponding locking receptacles 35 only by way of the multiplicity of displacement units 24.

In the next step, the linear unit 25 moves the locking head 27 back by a small measure, such that the pinch edges 31, 32 having the projecting peripheries of the cured half shells (not shown) are in a contacting position on top of one another and can adhesively bond to one another by means of a previously applied adhesive. To this end, the linear unit 25 can apply a defined tensile force and/or maintain a precisely defined position of the locking head 27. The spacing between the mold peripheries 33, 34 that can be seen in FIG. 10 is referred to as the adhesive gap and can be set and maintained by way of sensors or mechanical detents. A separate individual control unit for each individual displacement unit 24 is possible.

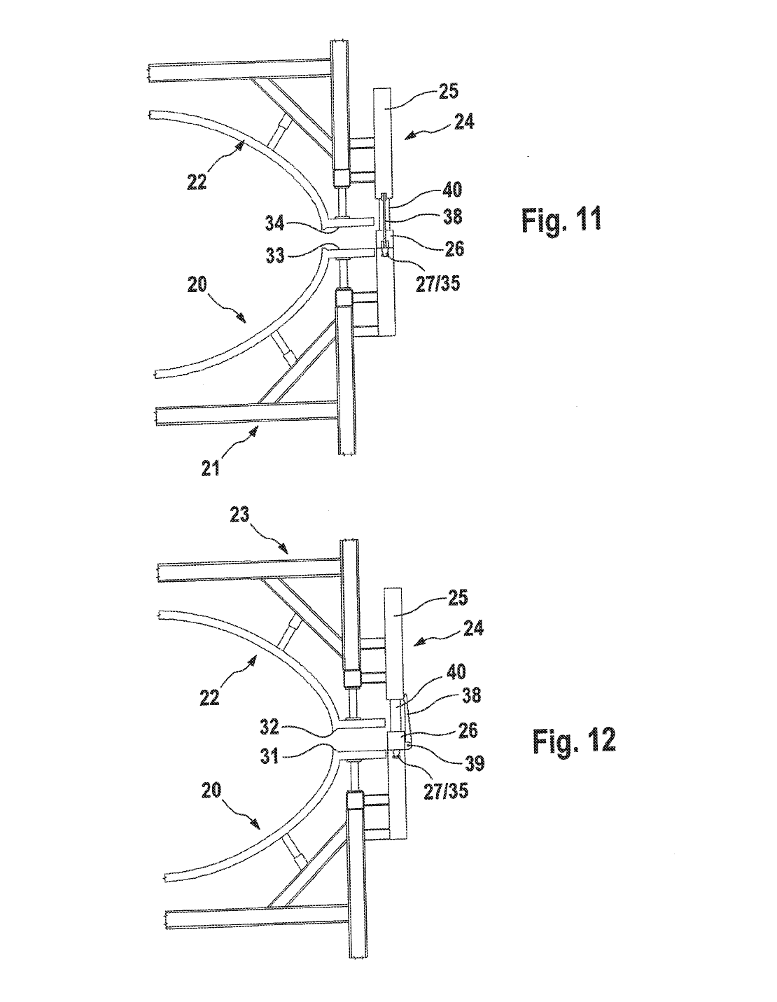

After the adhesive and the permanent connection of the half shells (not shown) have cured, the mold shells 20, 22 are mutually separated again by lifting the upper mold shell 22. To this end, the linear unit 25 is activated in order for the piston rod 40 to be deployed, see FIG. 11. The locking head 27 is preferably continuously locked in the locking receptacle 35. The half shell that until now has been adhering to the mold shell 22 is released or demolded, respectively, from the latter in that said mold shell 22 is lifted. The load that is supported by the displacement unit 24 or by the linear unit 25, respectively, is significantly reduced.

In the next step, the locking head 27 by the rotary unit 26 is rotated back about 90 degrees such that locking is released. The holding arm 38 also travels to the still vertical position shown in FIG. 12. Herein, or prior thereto, the upper mold shell 22 can be reconnected to the articulation system (not shown) which now supports the load of the movable frame 23 with the mold shell 22.

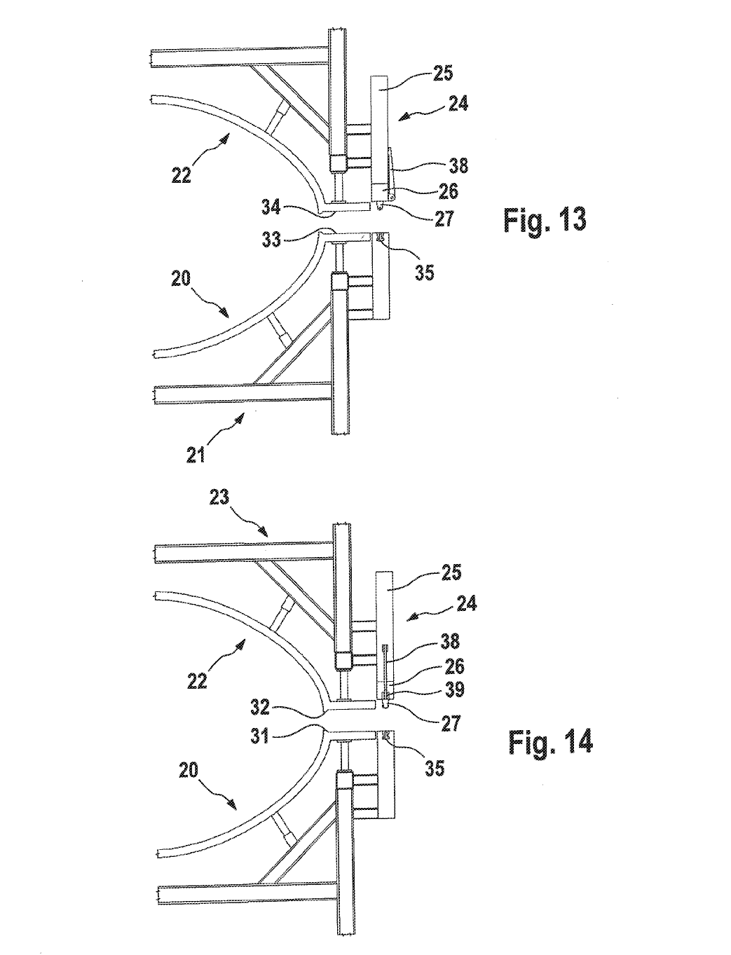

In the next step, the linear unit 25 completely retracts the piston rod 40, see FIG. 13. Lastly, the rotary unit 26 pivots the holding arm 38 which is (still) vertical back to the 0 degree parking position according to FIG. 14. The articulation system subsequently repositions the movable frame 23 with the mold shell 22 about 180 degrees back to the position according to FIG. 1, until said frame 23 is deposited on a floor.

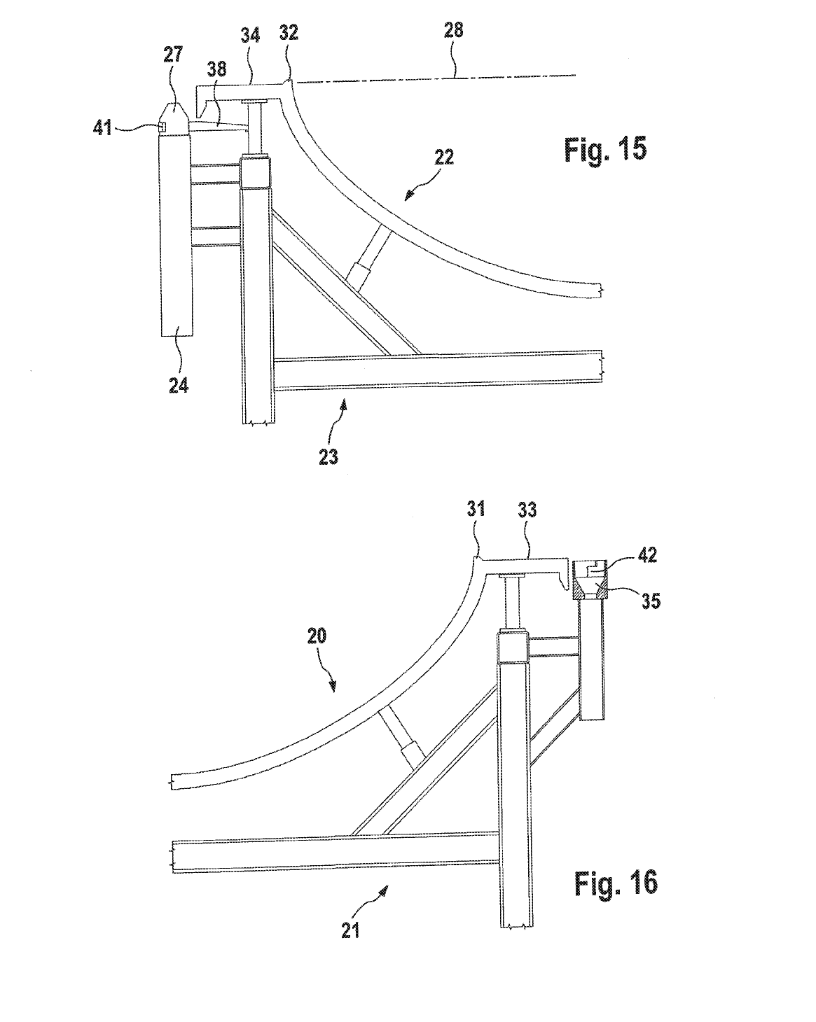

As an alternative to the aforementioned embodiments, the holding arm 38 can also be configured in a fixed horizontal manner on the rotary unit 26, see FIG. 15. In the parking position shown therein, the rotary unit 26 is lowered so far that the holding arm 38 is in a 45 degree parking position obliquely below the mold periphery 34 and thus does not constrict the operating region above the mold periphery 34. In this variant, a lateral pin 41 is moreover provided at the widest location of the locking head 27.

In a manner corresponding to the pin 41 and to the holding arm 38, the locking receptacle 35 in FIG. 16 at the entry region, that is to say at the widest location thereof, has two mutually opposite L-shaped grooves of which only one groove 42 is visible here. The grooves here have the function of a gate guide such that the pin 41, the holding arm 38, on the one hand, and the grooves, on the other hand, can interact in the manner of a bayonet fitting. The holding arm 38 in this instance, apart from the function thereof of a securing means, at the same time has a function of a locking means.

Alternatively, only one of the two grooves is available, the latter then interacting with the holding arm 38 or the pin 41. For example, only the holding arm 38 without the pin 41 is available.

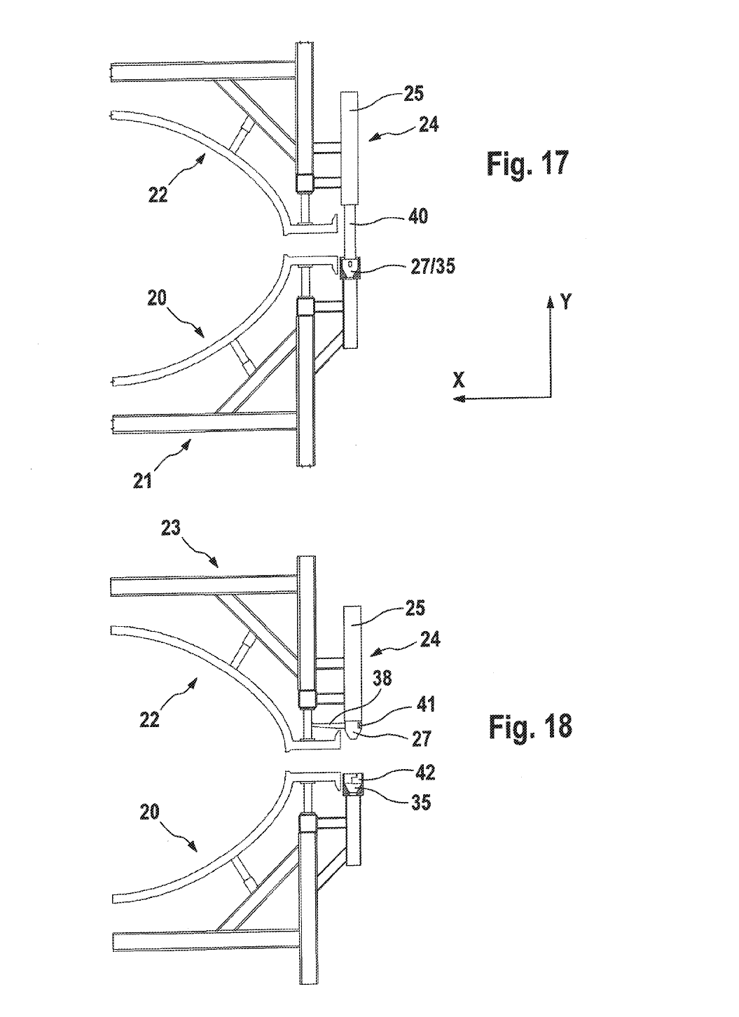

According to FIG. 17, the locking head 27 is retracted into the locking receptacle 35. At the same time, the holding arm 38 is pivoted to a position that is perpendicular to the image plane, such that the locking head 27 and the locking receptacle 35 are locked. In order for the lock to be opened, the holding arm 38 has to be pivoted back about 45 degrees in the direction towards the mold shell 22. The locking head 27 can subsequently be pulled out of the locking receptacle 35.

A further peculiarity can be derived from FIG. 2. The locking receptacle 35 is disposed in an upper end of a rod-shaped holder 43. The holder 43 is mounted on the frame 21 by means of two transverse supports 44, 45. The transverse supports 44, 45 thus form a mounting for the locking receptacle 35. The mounting is preferably configured so as to be adjustable in length, enabling tuning of the locking receptacle 35 in the direction of a double arrow 46, specifically parallel to the image plane and transverse to the direction of movement of the locking head 27. To this end, the transverse supports 44, 45 in terms of the effective length thereof can be variable such as by way of sections that are telescopic or can be screwed into one another. The direction of movement of the locking head 27 into the locking receptacle 35 is illustrated by a double arrow 47 in FIG. 2. Alternatively or additionally, the locking head 27 or the linear unit 24 is movable in a transverse manner in the direction of the double arrow 46, see also FIG. 6.

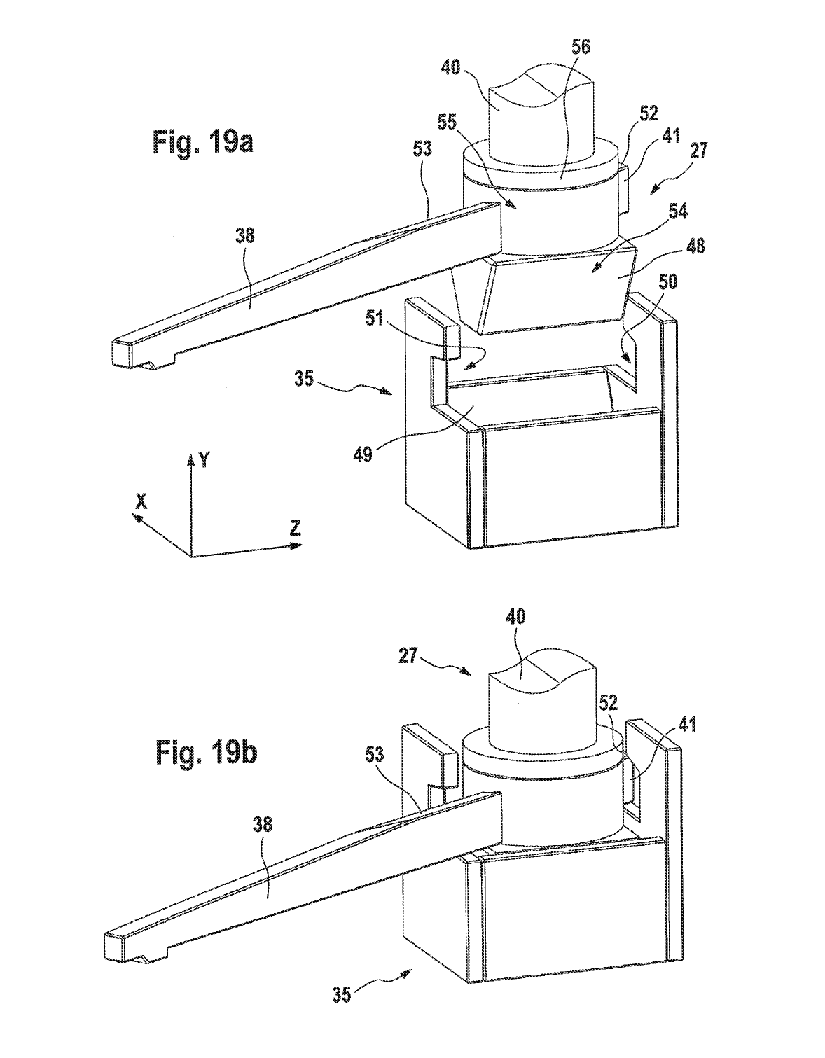

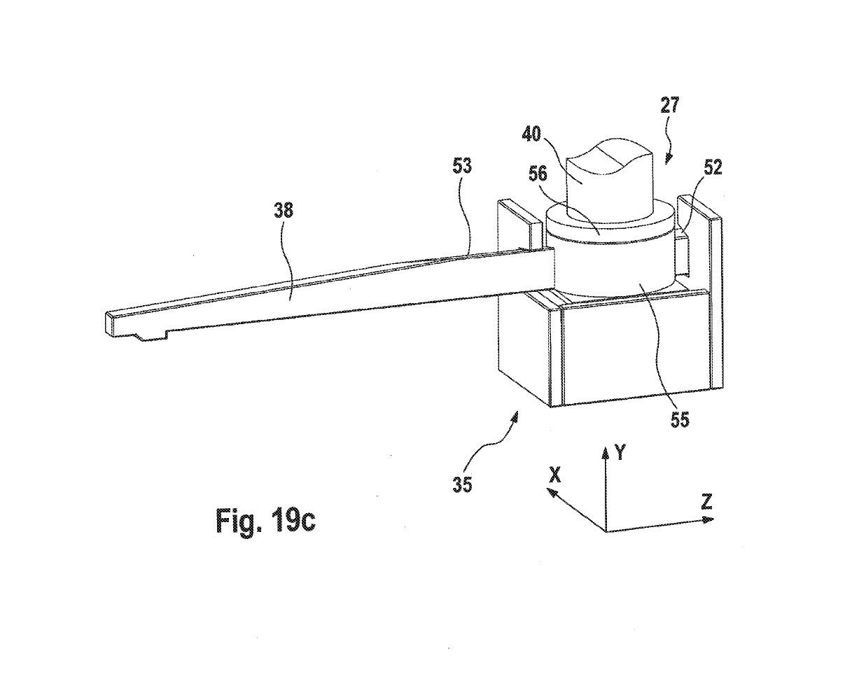

FIGS. 19a, 19b, 19c also show a horizontally fixed holding arm. Moreover, the locking head 27 and the locking receptacle 35 in this exemplary embodiment are of a deviating design.

The locking head 27 is configured so as to be wedge-shaped, having a trapezoidal cross section in the X-Y plane and a rectangular cross section in the Y-Z plane. Herein, the Z-direction runs approximately parallel to an articulation line (not shown) between the mold shells 20, 22 or in the longitudinal direction of a rotor blade, for a wind power plant, to be produced, respectively. The wedge shape of the locking head 27 guarantees centering or equalizing of deviations in the X-direction when the mold shells 20, 22 are brought together, respectively.

Additionally, the locking receptacle 35 in this case also has a wedge shape, specifically a wedge-shaped internal cross section such that wedge faces 48 on both sides of the locking head 27 can slide along wedge faces 49 on both sides of the locking receptacle 35.

The locking receptacle 35 here, instead of an L-shaped groove, has two wedge-shaped grooves 50, 51 in which the holding arm 38 and the pin 41 can engage. In a manner matching the wedge shape of the grooves 50, 51, the holding arm 38 and the pin 41 at least on the upper side are provided with oblique bearing faces 52, 53, the inclinations of the latter being adapted to the wedge shape of the grooves 50, 51.

The interaction between the locking head 27 and the locking receptacle 35 of this exemplary embodiment can be seen by means of FIGS. 19a, 19b, 19c. According to FIG. 19a, the holding arm 38 projects obliquely from the Y-Z plane, the pin 41 corresponding thereto. The locking head 27 in this position of the holding arm 38 can plunge into the locking receptacle 35. The wedge faces 48, 49 herein come to bear on one another. This position is illustrated in FIG. 19b. The holding arm 38 and the pin 41 subsequently are pivoted into the wedge-shaped grooves 50, 51. In order for this to be enabled, the locking head 27 is subdivided into a wedge 54 and a rotor 55. The holding arm 38 and the pin 41 are held on the rotor 55, while the wedge 54 can be fixedly connected to the piston rod 40. The rotor 55 by way of a pneumatic, hydraulic, or electric drive (not shown) is rotatable relative to the piston rod 40.

The cylindrical rotor 55 is mounted between the wedge 54 and a mounting plate 56 which can be fixedly connected to the piston rod 40.

### LIST OF REFERENCE SIGNS

20 Stationary mold shell

21 Frame

22 Mold shell

23 Movable frame

24 Displacement unit

25 Linear unit

26 Rotary unit

27 Locking head

28 Opening plane

29 Double arrow

30 Rotation arrow

31 Pinch edge

32 Pinch edge

33 Mold periphery

34 Mold periphery

35 Locking receptacle

36 Cams

37 Grooves

38 Holding arm

39 Articulation

40 Piston rod

41 Pin

42 Groove

43 Holder

44 Transverse support

45 Transverse support

46 Double arrow

47 Double arrow

48 Wedge face

49 Wedge face

50 Wedge-shaped groove

51 Wedge-shaped groove

52 Inclined face

53 Inclined face

54 Wedge

55 Rotor

56 Mounting plate

1. A molding tool assembly, in particular for producing rotor blades for wind power plants, comprising:
a first mold shell (20) and a second mold shell (22) each for receiving one workpiece part, wherein the two mold shells (20, 22) in a proximal position face one another but do not bear on one another;
a securing means for holding a workpiece part in at least one of the mold shells (20, 22); and
a centering means for mutually centering the two mold shells (20, 22) in the proximal position or during convergence of the mold shells,
wherein the securing means and the centering means are mechanically intercoupled.

2. The molding tool assembly according to claim 1, wherein the centering means and the securing means are intercoupled by common drive means.

3. The molding tool assembly according to claim 1, wherein:
the centering means each include a centering head and a centering receptacle;
the centering head is assigned to the one mold shell (22) and the centering receptacle is assigned to the other mold shell (20); and
the centering head and the centering receptacle are preferably configured so as to be conical and mutually matching.

4. The molding tool assembly according to claim 3, wherein the centering means and the securing means are mechanically intercoupled in such a manner that in the case of a movement of the centering head or of the centering receptacle in the direction towards the respective other mold shell (20, 22), the securing means or part of the latter is simultaneously moved in the direction towards the other mold shell (20, 22).

5. A molding tool assembly, in particular for producing rotor blades for wind power plants, comprising:
a first mold shell (20) and a second mold shell (22) each for receiving one workpiece part, wherein the two mold shells (20, 22) in a proximal position face one another but do not bear on one another;
a securing means for holding a workpiece part in at least one of the mold shells (20, 22), in particular according to one of the preceding claims; and
a locking means for a tensile-force-absorbing connection between the two mold shells (20, 22).

6. The molding tool assembly according to claim 5, wherein the securing means and the locking means are intercoupled by common drive means.

7. The molding tool assembly according to claim 5, wherein:
the locking means in each case include a locking head (27) and a locking receptacle (35);
the locking head (27) is assigned to the one mold shell (22) and the locking receptacle (35) is assigned to the other mold shell (20); and
the locking head (27) is connectable to the locking receptacle (35) preferably by plug-fitting and rotating.

8. The molding tool assembly according to claim 7, wherein the securing means and the locking means are mechanically intercoupled in such a manner that in the case of a movement of the locking head (27) or of the locking receptacle (35) the securing means is simultaneously moved.

9. The molding tool assembly according to claim 7, wherein the locking head (27) is rotatable from an ingress position to a locking position, and in particular from an initial position to the ingress position.

10. The molding tool assembly according to claim 9, wherein the locking head (27) is moved in a range between the initial position and the ingress position when a holding arm (38) of the securing means is moved from a securing position to a free position.

11. The molding tool assembly according to claim 5, wherein the locking means is assigned a linear unit (25) by way of which in particular a locking head (27) is movable substantially in the direction that is perpendicular to an opening plane (28) of the assigned mold shell (22).

12. The molding tool assembly according to claim 11, wherein the mold shells (20, 22) by means of the linear unit (25) are movable from the proximal position in the direction towards a contacting position in which the mold shells (20, 22) and/or workpiece parts that are lying in the mold shells are in mutual contact.

13. The molding tool assembly according to claim 5, wherein the locking means is assigned a rotary unit (26) by way of which a locking head (27) is rotatable relative to a locking receptacle (35).

14. The molding tool assembly according to claim 13, wherein the securing means comprises a holding arm (38) that is simultaneously pivotable by way of the rotary unit (26).

15. The molding tool assembly according to claim 7, wherein the locking head (27) is simultaneously a centering head, and wherein the locking receptacle (35) is simultaneously a centering receptacle.

16. The molding tool assembly according to claim 1, wherein the securing means comprises a holding arm (38) that is pivotable about a pivot axis and foldable about a folding axis that is perpendicular thereto.

17. The molding tool assembly according to claim 1, wherein the securing means, the centering means, and/or the locking means are part of a displacement unit (24), and wherein a plurality of displacement units (24) are provided at defined spacings along at least one of the two mold shells (20, 22), specifically along the longitudinal sides thereof.

18. A molding tool assembly, in particular for producing rotor blades for wind power plants, comprising:
a first mold shell (20) and a second mold shell (22) each for receiving one workpiece part, wherein the two mold shells (20, 22) in a proximal position face one another but do not bear on one another;
centering means provided for mutually centering the two mold shells (20, 22) in the proximal position, in particular according to one of the preceding claims; and
the centering means are assigned locking means in such a manner that, by way of the centering means and the locking means, a connection is establishable between the two mold shells (20, 22), wherein the connection also absorbs tensile forces.

19. The molding tool assembly according to claim 18, wherein the centering means act in a centering manner at least in one direction, in particular transversely to a longitudinal direction of the mold shells (20, 22).

20. The molding tool assembly according to claim 18, wherein the centering means are adjustable in a manner parallel to an opening plane (28), in particular transversely to a longitudinal direction of the mold shells (20, 22).

21. The molding tool assembly according to claim 18, wherein the locking means, for moving the two mold shells (20, 22) from the proximal position to an even more proximal position and vice versa, are connected to a drive unit.

22. A method for producing a workpiece from two half-shell type workpiece parts, in particular for producing a rotor wing for wind power plants, comprising using a molding tool assembly comprising:
a first mold shell (20) and a second mold shell (22) each for receiving one workpiece part, wherein the two mold shells (20, 22) in a proximal position face one another but do not bear on one another;
a securing means for holding a workpiece part in at least one of the mold shells (20, 22); and
a centering means for mutually centering the two mold shells (20, 22) in the proximal position or during convergence of the mold shells,
wherein the securing means and the centering means are mechanically intercoupled.
